(19) United States
(12) Patent Application Publication
(10) Pub. No.: US 2015/0341074 A1
(43) Pub. Date: Nov. 26, 2015

(54) AN APPARATUS COMPRISING: AN ANTENNA AND AT LEAST ONE USER ACTUATED SWITCH, A METHOD, AND A COMPUTER PROGRAM

(71) Applicant: NOKIA TECHNOLOGIES OY, Espoo (FI)

(72) Inventors: Jari Saukko, Tampere (FI); Mikko Komulainen, Oulu (FI)

(21) Appl. No.: 14/758,331

(22) PCT Filed: Dec. 31, 2012
(86) PCT No.: PCT/FI2012/051310

§ 371 Date: Jun. 29, 2015

(51) Int. Cl. H04B 1/401; H04M 1/725

(52) U.S. Cl. CPC H04B 1/401; H04M 1/72577

(57) ABSTRACT

An apparatus (2) comprising: an antenna (4); at least one user actuated switch (6) configured, only when enabled, to be user-actuated to provide user input to the apparatus (2); and circuitry (10) configured to detect an antenna interference condition and configured to control enablement and disablement of the user actuated switch (6), in response to detected antenna interference condition (12).

### TECHNOLOGICAL FIELD

Embodiments of the present invention relate to an apparatus comprising: an antenna and at least one user actuated switch, a method, and a computer program.

### BACKGROUND

The efficiency of an antenna is dependent upon its impedance and how well that is matched to the impedance of the medium it interfaces with.

The impedance of an antenna includes a reactive component and it is therefore dependent on frequency.

Antennas are often very carefully designed so that they have an acceptable impedance across a desired band or bands of frequencies. Particular care is required if the antenna is within a mobile device because the impact of components of the device that are close to the antenna on the operation of the antenna must also be considered. As the impedance of the antenna is reactive it is modified if the local electric or magnetic field alters. The operation of an antenna can therefore be compromised by the presence of a local conductor or dielectric object.

### BRIEF SUMMARY

According to various, but not necessarily all, embodiments of the invention there is provided an apparatus comprising: an antenna; at least one user actuated switch configured, only when enabled, to be user-actuated to provide user input to the apparatus; and circuitry configured to detect an antenna interference condition and configured to control enablement and disablement of the user actuated switch, in response to a detected antenna interference condition.

According to various, but not necessarily all, embodiments of the invention there is provided an apparatus comprising: at least one processor; and at least one memory including computer program code the at least one memory and the computer program code configured to, with the at least one processor, cause the apparatus at least to perform: detecting an antenna interference condition; and controlling, in response to a detected antenna interference condition, enablement and disablement of a user actuated switch.

According to various, but not necessarily all, embodiments of the invention there is provided a method comprising: detecting an antenna interference condition; and controlling, in response to a detected antenna interference condition, enablement and disablement of a user actuated switch.

### BRIEF DESCRIPTION

For a better understanding of various examples of embodiments of the present invention reference will now be made by way of example only to the accompanying drawings in which:

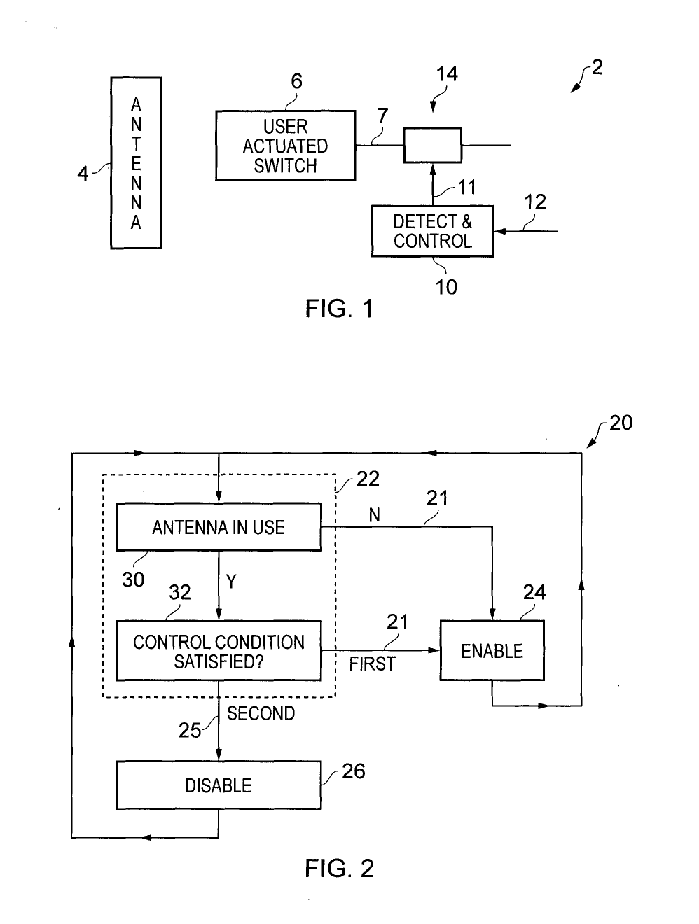

FIG. 1 illustrates an example of an apparatus;

FIG. 2 illustrates an example of a method that may be performed by the apparatus;

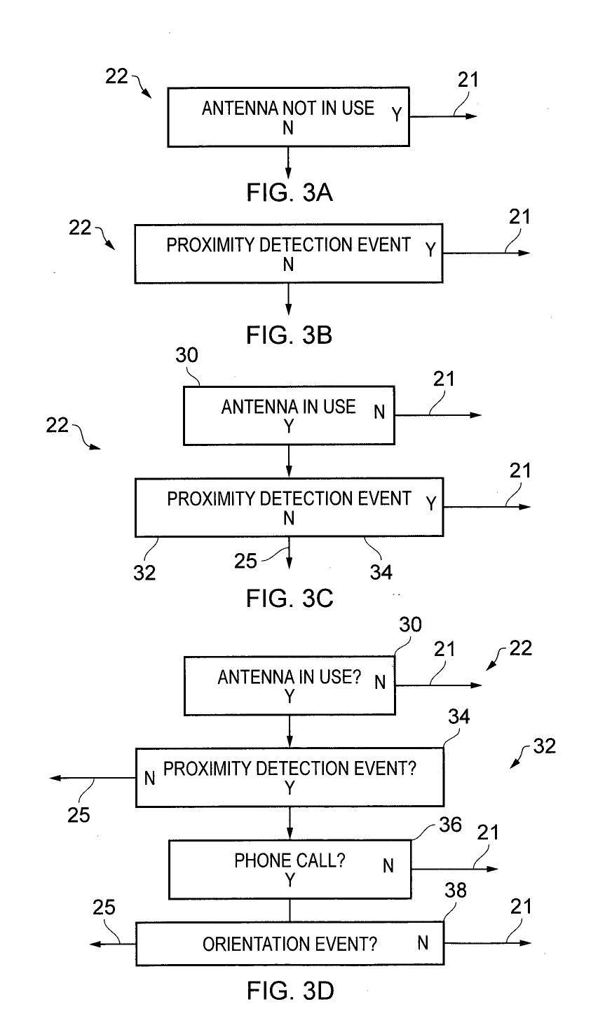

FIG. 3A illustrates determining that a first antenna interference condition is satisfied when the antenna is not in use;

FIG. 3B illustrates determining that a first antenna interference condition is satisfied when a proximity detection event occurs;

FIG. 3C illustrates determining that a first antenna interference condition is satisfied when a proximity detection event has occurred or when the antenna is not in use;

FIG. 3D illustrates determining that a first antenna interference condition is satisfied when the antenna is not in use or when a (verified) proximity detection event has occurred;

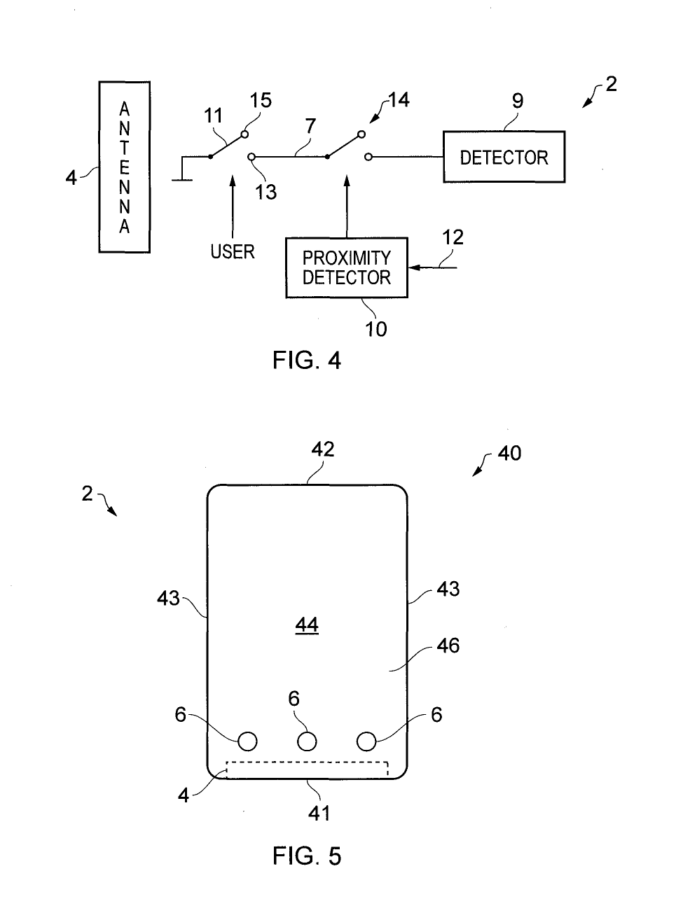

FIG. 4 illustrates an example of the apparatus illustrated in FIG. 1;

FIG. 5 illustrates an example of the apparatus;

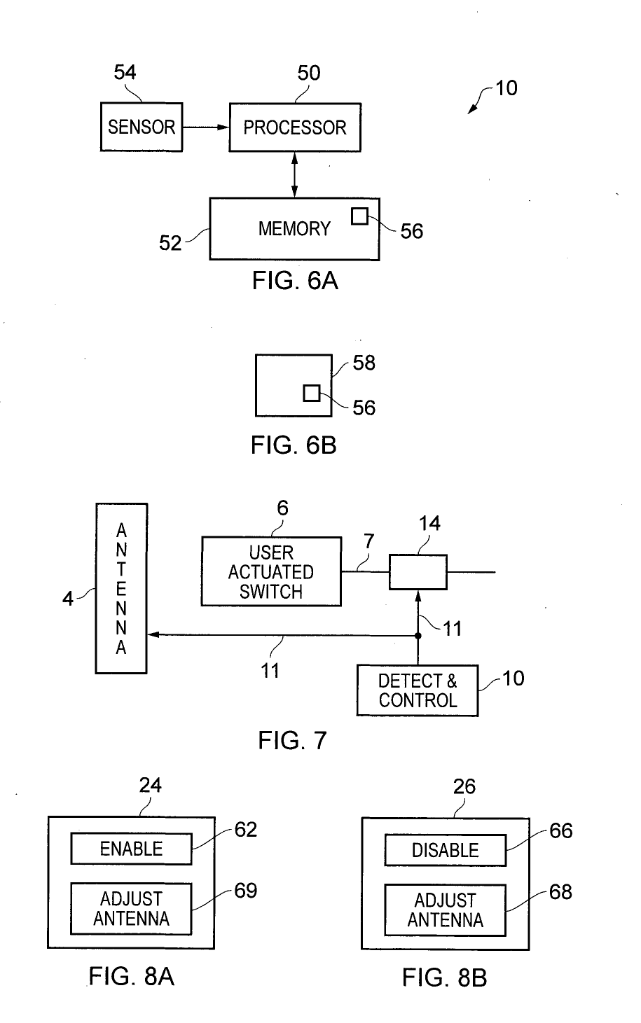

FIG. 6A illustrates an example of control circuitry;

FIG. 6B illustrates an example of a computer program.

FIG. 7 illustrates a modified example of the apparatus of FIG. 1; and

FIGS. 8A and 8B illustrate modifications to the method of FIG. 2.

### DETAILED DESCRIPTION

The Figures illustrate an apparatus 2 comprising: an antenna 4; at least one user actuated switch 6 configured, only when enabled, to be user-actuated to provide user input to the apparatus 2; and circuitry 10 configured to detect an antenna interference condition 12 and configured to control enablement and disablement of the user actuated switch 6, in response to a detected antenna interference condition 12.

FIG. 1 illustrates an example of an apparatus 2. This example of the apparatus is a radio communications apparatus that uses an antenna 4 to receive radio signals and/or transmit radio signals.

This example of the apparatus 2 may be a user device that is intended for operation by an end-user or a module for a user device.

Examples of user devices include electronic devices that communicate by radio. The communication may be over short distances or longer distances. It may for example involve communication in a cellular radio communication network or some other radio network. The communication may occur over any method of electromagnetic energy transfer, for example the communication may occur only over the near field, only over the far field or both the near and far fields of any antenna implemented in the electronic device.

In some but not necessarily all embodiments the apparatus 2 may be operable as a mobile cellular telephone.

The apparatus 2 comprises an antenna 4 and at least one user actuated switch 6 that allows user control of the apparatus 2.

The user actuated switch 6 is configured, but only when enabled, to be user-actuated to provide user input to the apparatus 2.

Control circuitry 10 is configured to control whether the user actuated switch 6 is enabled and can be user-actuated to provide user input to the apparatus 2 or whether the user actuated switch 6 is disabled and cannot be user-actuated to provide user input to the apparatus 2.

The control circuitry 10 is configured to detect an antenna interference condition 12 and configured to control enablement and disablement of the user actuated switch 6 in response to a detected antenna interference condition 12 using control signal 11.

The control circuitry 10 is configured to enable/disable the user actuated switch 6 by controlling a conductive path 7 to/from the user actuated switch 6.

For example, a switch 14, may be controlled by control circuitry 10 to enable the at least one user actuated switch 6 by completing the conductive path 7 to/from the user actuated switch 6. The switch 14, may be controlled by control circuitry 10 to disable the at least one user actuated switch 6 by interrupting the conductive path 7 to/from the user actuated switch 6. Interrupting can for example involve connecting a switch to open or short circuit or to any other impedance appropriate for the antenna 4. The switch 14 may be an electrically actuated switch, for example, a field effect transistor.

The user actuated switch 6 comprises conductive components. The switch 6 may be an electro-mechanical switch.

For example, the user actuated switch 6 may be a mechanical switch, as illustrated in FIG. 4, where a first conductive element 11 is moved between a first terminal 15 and a second terminal 13. When the switch 6 is open, the first conductive element 11 is open or short circuit or connected to any other impedance appropriate for the antenna 4. As an alternative example, the switch 6 may be an electrical switch such as a capacitive sensor formed from conductive electrodes. When the switch 14 is opened by the control circuitry 10, one or both of the electrodes is open circuit and has a floating electrical potential.

FIG. 2 illustrates an example of a method 20 that may be performed by the apparatus 2.

The control circuitry 10 is configured to enable the at least one user actuated switch 6 when a first antenna interference condition is satisfied. The control circuitry 10 is configured to disable the at least one user actuated switch 6 when a second antenna interference condition is satisfied.

The object of the method is to reduce interference at the antenna 4 while not compromising use of the apparatus 2. The method selectively enables/disables the user actuated switch 6. Disabling the switch 6 improves antenna performance but makes the switch 6 unavailable for user actuation. Enabling the switch reduces antenna performance but makes the switch 6 available for user actuation.

The method 20 uses an algorithm block 22 to determine 21 when a first antenna interference condition is satisfied and then uses block 24 to control enablement of the user actuated switch 6.

The method 20 uses the algorithm block 22 to determine 25 when a second antenna interference condition is satisfied and then uses block 26 to control disablement of the user actuated switch 6.

The algorithm block 22 balances the need for reduced antenna interference and the need for enabling user input via the user actuated switch 6.

In the illustrated example, the algorithm operates by temporarily enabling the user actuated switch 6 when there is a likelihood that it will be used. Consequently, the algorithm operates to disable the user actuated switch 6 whenever interference at the antenna 4 is likely but the likelihood of user actuation of the switch 6 is small. If the likelihood of interference decreases (e.g. the antenna is not in use) or the likelihood of user actuation of the user actuated switch 6 increases then the user actuated switch 6 may be enabled.

Referring to the example illustrated in FIG. 2, at block 22, it is determined 21 whether a first antenna interference condition is satisfied or determined 25 whether a second interference condition is satisfied.

Block 22 comprises blocks 30 and 32.

At block 30, it is determined 21 that a first antenna interference condition is satisfied when the antenna 4 is not in use. The method then moves to block 24 to enable the user actuated switch 6. Alternatively, if the antenna 4 is in use, the method moves to block 32.

At block 32, it is determined 21 that a first antenna interference condition is satisfied when a control condition is satisfied. The control condition may be satisfied, for example, when there is an increased likelihood that a user will actuate the user actuated switch 6. Alternatively, if the control condition is not satisfied, the method moves to block 26 to disable the user actuated switch 6.

It will be appreciated that the control condition may itself be a single condition or a plurality of conditions combined using conditional logic.

The control condition may, for example, require that a proximity detection event has occurred. The proximity detection event may indicate the proximity of another body to the apparatus 2 or, it may be more sophisticated, indicating the proximity of a user digit to the apparatus 2 using, for example, 3D sensors or indicating that the proximal body is likely to be a user digit (e.g. because of a change in state or orientation of the apparatus 2 for example).

Further additional conditions may need to be fulfilled if the control condition requires that a user-digit proximity detection event has occurred. Such further conditions may, for example, relate to the environment of the apparatus (e.g. not in a pocket), or its orientation (e.g. not face down on a surface so that switch cannot be actuated).

Further conditions may need to be fulfilled if the control condition requires that user-actuation of the switch 6 is currently possible, meaningful or likely. For example, a further condition may require that the user actuated switch 6 has a function in the current operational state of the apparatus. The operational state of the apparatus 2 may change, for example, by opening and closing applications or by starting and ending functions. Other examples of requirements may be that there is not an on-going telephone call and/or that an input lock is not in operation.

The control condition may, for example, require that a user action has occurred that makes use of the switch 6 more likely. The user action may, for example, involve changing an orientation of the apparatus 2 and/or changing the operational state of the apparatus 2.

Referring to FIG. 3A, in this example, the first antenna interference condition is that the antenna 4 is not in use. At block 22, it will be determined 21 that a first antenna interference condition is satisfied (causing enablement of the user actuated switch 6) when the antenna 4 is not in use.

Referring to FIG. 3B, in this example, the first antenna interference condition is that a proximity detection event has occurred. At block 22, it will be determined 21 that a first antenna interference condition is satisfied (causing enablement of the user actuated switch 6) when the proximity detection event occurs.

Referring to FIG. 3C, in this example, the first antenna interference condition is that a proximity detection event has occurred or that the antenna 4 is not in use.

At block 22, in this example, first it will be determined 21, at block 30 that a first antenna interference condition is satisfied (causing enablement of the user actuated switch 6) when the antenna 4 is not in use. If the antenna 4 is in use, the method moves to block 32.

Next at block 32, it will be determined 21 that a first antenna interference condition is satisfied (causing enablement of the user actuated switch 6) when a proximity detection event occurs. If the proximity detection event does not occur, it will be determined 25 that a second antenna interference condition is satisfied (causing disablement of the user actuated switch 6).

Referring to FIG. 3D, in this example, the first antenna interference condition is that the antenna is not in use or that a (verified) proximity detection event has occurred.

At block 22, in this example, it will be determined 21, at block 30 that a first antenna interference condition is satisfied (causing enablement of the user actuated switch 6) when the antenna 4 is not in use.

Next at block 32, it will be determined 21 that a first antenna interference condition is satisfied (causing enablement of the user actuated switch 6) when a (verified) proximity detection event occurs. In this example, the proximity detection event is verified if the apparatus 2 is not in a phone call or, if it is in a phone call, it is oriented so that it is unlikely to be adjacent a user's head.

Block 32 is divided into sub-blocks 34, 36, 38.

At sub-block 34 it is determined if a proximity detection event has occurred. If a proximity detection event has not occurred it will be determined 25 that a second antenna interference condition is satisfied (causing disablement of the user actuated switch 6). If a proximity detection event has occurred, the method passes to sub-block 36.

At sub-block 36 it is determined if a phone call is in progress. If a phone call is not in progress, it will be determined 21 that a first antenna interference condition is satisfied (causing enablement of the user actuated switch 6). If a phone call is in progress the method passes to sub-block 38.

At sub-block 38 it is determined if an orientation event has occurred. The orientation event may occur, for example, if the apparatus 2 is oriented so that a top of a housing of the apparatus is vertically displaced relative to a base of the housing which might indicate that the apparatus is being held against a user's head during a phone conversation.

If the orientation event has not occurred it will be determined 21 that a first antenna interference condition is satisfied causing enablement of the user actuated switch 6.

If the orientation event has occurred it will be determined 25 that a second antenna interference condition is satisfied causing disablement of the user actuated switch 6.

FIG. 4 illustrates an example of the apparatus 2 illustrated in FIG. 1. In this example, the control circuitry 10 comprises a proximity detector.

The control circuitry 10 controls the opening and closing of switch 14. When the switch 14 is open the conductive path 7 between the at least one user actuated switch 6 and a detector 9 is open circuit. When the switch 14 is closed the conductive path 7 between the at least one user actuated switch 6 and a detector 9 is a closed circuit. The apparatus 2 may operate as previously described.

FIG. 5 illustrates an example of the apparatus 2. The apparatus 2 comprises a handset housing 40. The handset housing 40 may in some examples, be sized to be carried in a palm of one hand. That is, it may be hand-portable.

The handset housing 40 has a base 41, a top 42, sides 43 and faces 44. In this example, the antenna 4 is located within the handset housing 40 at or near the base 41.

The apparatus 2 comprises multiple user actuated switches 6. Each of these switches 6 is configured, only when enabled, to provide a different user input to the apparatus 2.

The control circuitry 10, previously described but not illustrated in FIG. 5, is configured to detect an antenna interference condition 12 and configured to control enablement and disablement of the multiple user actuated switches 6, in response to a detected antenna interference condition 12. Although the multiple user actuated switches 6 are, in this example, positioned on the face 44 of the handset housing 40, one or more of the multiple switches may be positioned on any other surface of the housing handset 40.

The face 44, or any other surface of the handset housing 40 may be configured to provide a proximity detector used by the control circuitry 10.

For example, the face 44 may comprise a transmitter and a receiver that are configured to detect a proximal object. The transmitter and receiver may, for example, be an ultra-sound transmitter and an ultra-sound receiver or an infra-red light transmitter and an infra-red light receiver.

As another example, any surface of the handset housing 40 (base 41, top 42, sides 43, faces 44) may comprise a capacitive touch sensor or other capacitive detector. One type of capacitive touch sensor comprises one or more detection electrodes connected via a multiplexer to a first input of a capacitance detector, which may be a low impedance charge amplifier. The other, second input of the capacitance detector is connected to a guard electrode that is positioned in front of or behind the detection electrodes but exposes at least portions of the underlying detection electrodes. A time-varying electric field is applied to the guard electrode. In the absence of a proximal conductive object, such as a finger, the time-varying electric field between the first and second input of the capacitance detector is fixed for a particular detection electrode or particular detection electrodes. When a proximal conductive, or dielectric object such as a user's finger, approaches the detection electrodes, the electric field at the detection electrodes alters and the time-varying electric field between the first and second input of the detector changes. This change is detected by the capacitance detector. This type of touch sensor operates not only as a detector of touch location (x,y) but also as a three-dimensional (3D) touch input detector that detects vertical location z of a finger before it touches the screen.

FIG. 6A illustrates an example of control circuitry 10. In this example, the control circuitry 10 comprises a sensor 54 which may be used to sense information used to determine whether a first antenna interference condition and/or a second antenna interference condition has been satisfied.

The control circuitry 10 also comprises a controller which performs the functions of the control circuitry 10 such as the methods illustrated in FIGS. 2, and 3A to 3D.

Implementation of the controller can be in hardware alone (a circuit, a processor . . . ), have certain aspects in software including firmware alone or can be a combination of hardware and software (including firmware).

The controller may be implemented using instructions that enable hardware functionality, for example, by using executable computer program instructions in a general-purpose or special-purpose processor that may be stored on a computer readable storage medium (disk, memory etc) to be executed by such a processor.

In the illustrated example, the controller comprises a processor 50 and a memory 52. The processor 50 is configured to read from and write to the memory 52. The processor 50 may also comprise an output interface via which data and/or commands are output by the processor 50 and an input interface via which data and/or commands are input to the processor 50.

The memory 52 stores a computer program 56 comprising computer program instructions that control the operation of the apparatus 2 when loaded into the processor 50. The computer program instructions 56 provide the logic and routines that enables the apparatus to perform the methods illustrated in FIGS. 2 and 3A to 3D.

The processor 50 by reading the memory 52 is able to load and execute the computer program 56.

The apparatus therefore comprises: at least one processor; and at least one memory including computer program code, the at least one memory and the computer program code configured to, with the at least one processor, cause the apparatus at least to perform: detect an antenna interference condition 12; and

control, in response to a detected antenna interference condition 12, enablement and disablement of a user actuated switch 6.

The computer program may arrive at the apparatus 2 via any suitable delivery mechanism 58, as illustrated in FIG. 6B. The delivery mechanism 58 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 56. The delivery mechanism may be a signal configured to reliably transfer the computer program 56. The apparatus 2 may propagate or transmit the computer program 56 as a computer data signal.

Although the memory 52 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions, and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

FIG. 7 illustrates a modified example of the apparatus 2 of FIG. 1. Like references are used to designate like components. The operation of the apparatus 2 of FIG. 7 is very similar to the operation of the apparatus 2 of FIG. 1. Emphasis will be placed below on the differences.

In FIG. 7, the antenna 4 is an electrically adjustable antenna. The control circuitry 10 is configured to detect an antenna interference condition 12 and configured to control enablement and disablement of the user actuated switch 6 in response to a detected antenna interference condition 12 using control signal 11. However, the control signal 11 is also provided to the electrically adjustable antenna 4 to adjust the antenna. The purpose of the antenna adjustment is to mitigate the impact, on the antenna 4, of enabling/disabling the user actuated switch 6. The antenna adjustment may comprise one or more of the following, and not limited to, adjustments of: antenna input impedance, tuning the resonant frequency or frequencies of the antenna, the phase of the antenna, the bandwidth of the antenna, the active frequency band of the antenna, etc.

FIG. 8A illustrates a consequential modification to the method of FIG. 2. Block 24 is modified to not only enable 62 the user actuated switch 6 but also to adjust 64 the antenna 4 to mitigate the impact, on the antenna 4, of enabling the user actuated switch 6.

FIG. 8B illustrates a consequential modification to the method of FIG. 2. Block 26 is modified to not only disable 66 the user actuated switch 6 but to adjust 68 the antenna 4 to mitigate the impact, on the antenna 4, of disabling the user actuated switch 6.

The antenna 4 may be configured to operate in one or more of a plurality of operational resonant frequency bands. For example, the operational frequency bands may include (but are not limited to) Long Term Evolution (LTE) (US) (734 to 746 MHz and 869 to 894 MHz), Long Term Evolution (LTE) (rest of the world) (791 to 821 MHz and 925 to 960 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hiper local area network (HiperLAN) (5150-5850 MHz); global positioning system (GPS) (1570.42-1580.42 MHz); US-Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); time division synchronous code division multiple access (TD-SCDMA) (1900 MHz to 1920 MHz, 2010 MHz to 2025 MHz), ultra wideband (UWB) Lower (3100-4900 MHz); UWB Upper (6000-10600 MHz); digital video broadcasting-handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra high frequency (RFID UHF) (433 MHz, 865-956 MHz, 2450 MHz).

A frequency band over which an antenna can efficiently operate is a frequency range where the antenna's return loss is less than an operational threshold. For example, efficient operation may occur when the antenna's return loss is better than (that is, less than) −4 dB or −6 dB.

As used here ‘module’ refers to a unit or apparatus that excludes certain parts/components that would be added by an end manufacturer or a user.

The blocks illustrated in the FIGS. 2 and 3A to 3D may represent steps in a method and/or sections of code in the computer program 56. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-20. (canceled)

21. An apparatus comprising:
an antenna;
at least one user actuated switch configured, when enabled, to be user-actuated to provide user input to the apparatus; and
circuitry configured to detect an antenna interference condition and configured to control enablement and disablement of the user actuated switch, in response to a detected antenna interference condition.

22. An apparatus as claimed in claim 21, wherein the circuitry is configured to enable the at least one user actuated switch when a first antenna interference condition is satisfied.

23. An apparatus as claimed in claim 22, wherein the first antenna interference condition is satisfied is that the antenna is not in use.

24. An apparatus as claimed in claim 22, wherein the first antenna interference condition is satisfied is that a proximity detection event has occurred.

25. An apparatus as claimed in claim 22, wherein the first antenna interference condition is satisfied is that the antenna is in use and that a proximity detection event has occurred.

26. An apparatus as claimed in claim 22, wherein the first antenna interference condition is satisfied is that a verified proximity detection event has occurred.

27. An apparatus as claimed in claim 22, wherein the circuitry is configured to disable the at least one user actuated switch when a second interference condition is satisfied.

28. An apparatus as claimed in claim 27, wherein the second antenna interference condition is satisfied is that the antenna is in use and that a proximity detection event has not occurred.

29. An apparatus as claimed in claim 21, wherein the circuitry is configured to control a conductive path between the at least one user actuated switch and a detector.

30. An apparatus as claimed in claim 29, wherein the circuitry is configured to enable the at least one user actuated switch by completing the conductive path between the at least one user actuated switch and the detector.

31. An apparatus as claimed in claim 29, wherein the circuitry is configured to disable the at least one user actuated switch by interrupting the conductive path between the at least one user actuated switch and the detector.

32. An apparatus as claimed in claim 21, wherein the circuitry comprises a proximity detector.

33. An apparatus as claimed in claim 21, wherein the circuitry comprises a capacitive touch sensor.

34. An apparatus as claimed in claim 21, wherein the circuitry comprises a three dimensional touch input device.

35. An apparatus as claimed in claim 21, wherein the user actuated switch comprises conductive components.

36. An apparatus as claimed in claim 21, wherein the user actuated switch is an electrical switch.

37. An apparatus as claimed in claim 21, further comprising a housing having a base, sides and a top, wherein the antenna is located at the base and the user actuated switch is located near the base.

38. An apparatus as claimed in claim 21, further comprising multiple user actuated switches each of which is configured, only when enabled, to provide a different user input to the apparatus; wherein the circuitry is configured to detect an antenna interference condition and configured to control enablement and disablement of at least some of the multiple user actuated switches, in response to a detected antenna interference condition.

39. An apparatus comprising: at least one processor; and at least one memory including computer program code the at least one memory and the computer program code configured to, with the at least one processor, cause the apparatus at least to perform:
detecting an antenna interference condition; and
controlling, in response to a detected antenna interference condition, enablement and disablement of a user actuated switch.

40. A method comprising:
detecting an antenna interference condition; and
controlling, in response to a detected antenna interference condition, enablement and disablement of a user actuated switch.
